(19) United States
(12) Patent Application Publication
(10) Pub. No.: US 2003/0071016 A1
(43) Pub. Date: Apr. 17, 2003

(54) Patterned structure reproduction using nonsticking mold

(76) Inventors: Wu-Sheng Shih, Rolla, MO (US); James E. Lamb III, Rolla, MO (US); Mark Daffron, Rolla, MO (US)

Correspondence Address: HOVEY WILLIAMS TIMMONS & COLLINS, 2405 GRAND BLVD., SUITE 400, KANSAS CITY, MO, 64108

(21) Appl. No.: 10/267,953

(22) Filed: Oct. 8, 2002

Related U.S. Application Data
(60) Provisional application No. 60/328,841, filed on Oct. 11, 2001.

(51) Int. Cl. C03C 25/68

(52) U.S. Cl. 216/54

(57) ABSTRACT

Novel nonstick molds and methods of forming and using such molds are provided. The molds are formed of a nonstick material such as those selected from the group consisting of fluoropolymers, fluorinated siloxane polymers, silicones, and mixtures thereof. The nonstick mold is imprinted with a negative image of a master mold, where the master mold is designed to have a topography pattern corresponding to that desired on the surface of a microelectronic substrate. The nonstick mold is then used to transfer the pattern or image to a flowable film on the substrate surface. This film is subsequently cured or hardened, resulting in the desired pattern ready for further processing.

### RELATED APPLICATIONS

This application claims the priority benefit of a provisional application entitled PATTERNED STRUCTURE REPRODUCTION USING INHERENT, NON-STICKING MOLD, Serial No. 60/328,841, filed Oct. 11, 2001, incorporated by reference herein.

### BACKGROUND OF THE INVENTION

1. Field of the Invention

The present invention is broadly directed towards nonstick molds, methods of forming such molds, and methods of using these molds to transfer structural patterns onto other surfaces. The inventive molds are useful for the manufacturing of microelectronic, optoelectronic, photonic, optical, flat panel display, microelectromechanical system (MEMS), bio-chip, and sensor devices.

2. Description of the Prior Art

Integrated circuit (IC) fabrication is based upon the construction of ultrafine structures onto an object surface. Currently, photolithography is used to make these structures. A photosensitive material known as a photoresist is coated onto a surface at a certain thickness. This photoresist-coated surface is then illuminated with the appropriate wavelength of light and through a mask that has the desired structural pattern. The light-exposed surface is then developed with a suitable photoresist developer. A positive or negative pattern of the mask—depending upon the type of photoresist used—is transferred to the photoresist layer. Subsequently, the developed surface is etched using a wet or dry chemistry technique to etch the areas not covered by the photoresist. Finally, the photoresist is stripped, either by wet chemistry, dry chemistry, or both. The result is that the desired pattern is constructed onto the surface for further processing.

The photolithographyprocess involves the use of complicated tooling, tedious processing, and various noxious chemicals. In an effort to simplify the lithography process, a new technique, imprint lithography, has been developed to pattern microstructures onto a surface (Chou et al., Appl. Phys. Lett., 67(21), 3114-3116 (1995); Chou et al., J Vac. Sci. Technol., B 14(6), 4129-4133 (1996); U.S. patent application Ser. No. 2001/0040145 A1 to Wilson et al.). Imprint lithography involves applying a flowable material to a surface with a spin-coating process or other techniques. A mold with the desired structural pattern is then imprinted into the spin-coated material under the appropriate conditions. The material is cured or hardened using a thermal or a photo process. When the mold is released from the imprinted surface, the desired structural pattern remains on the surface.

The release of the mold becomes a critical step because the molded material tends to stick to the mold surface if the surface does not have certain properties. Current molds are made of quartz, silicon, silicon dioxide, or even metals. However, these materials do not possess adequate surface properties to facilitate the mold-releasing process. Therefore, two approaches have been pursued to facilitate the release of the mold from the molded material. One approach involves coating the mold surface with a thin film of a nonstick substance. This thin film can be applied by using several methods: dipping the mold into an appropriate chemical media, or applying it using plasma sputtering, plasma-enhanced chemical vapor deposition, or vacuum evaporation. This thin film is primarily a fluorocarbon polymer which is similar to the material sold under the trademark Teflon®. Fluorocarbon polymer films have very low surface energy, thus making them excellent nonstick materials. However, this nonstick property also makes depositing such a film onto the mold surface rather difficult. Moreover, the film needs to be very thin in order to maintain the critical dimension (CD) of the patterned structure on the molded surface.

Another approach to facilitating the mold's release is to add mold-releasing agents to the molded materials. However, this can alter the original properties of the materials and adversely affect subsequent processing. The mold-releasing agents can also deteriorate the adhesion of the molding materials at the substrate surface. Another difficulty is caused by the fact that different molding materials may need different mold-releasing agents to achieve material compatibility.

U.S. patent application Ser. No. 2001/0040145 A1 to Wilson et al. discloses a method for “step and flash imprint lithography.” This method utilizes a mold with a relief structure to transfer the pattern images onto a transfer layer on a substrate, through a polymerizable fluid. The mold is held at a certain distance from the transfer layer surface, and a polymerizable fluid is filled in the mold relief structure from the perimeter of the mold. Plasma etch of the molded polymer (polymerized fluid) and of the transfer layer is required. Various mold materials are disclosed, with quartz being the preferred mold material. However, the Wilson et al. application teaches that the mold surface must be treated with a surface modifying agent to facilitate release of the mold from the solid polymeric material. In addition, the mold of the Wilson et al. application must be treated with a surface-modifying agent using a plasma technique, a chemical vapor deposition technique, a solution treatment technique, or a combination of the techniques mentioned above.

Hirai et al., Journal of Photopolymer Science and Technology, 14(3), 457-462 (2001), describe a method of depositing a fluoropolymer onto a mold surface by the vacuum evaporation of FEP (fluorinated ethylene propylene) polymer to improve the release of the mold from the resist polymer. The FEP polymer is heated to about 555° C. at a total pressure of 0.028 Torr with a very low deposition rate. To improve the mold durability, the mold must be heated to 200° C. during FEP vacuum evaporation deposition, which will further lower the FEP deposition rate. As a result, it requires a much longer deposition time in order to achieve the desired thickness of fluorocarbon polymer at such a high mold temperature when compared to the deposition time needed if the mold is not heated. Another drawback is that the FEP polymer decomposes at 555° C. leading to the conclusion that the film deposited on the mold surface has a different molecular structure and surface properties than that of the original FEP polymer.

Hirai et al. also teach an alternative mold surface treatment method wherein the mold is dipped into a solution that consists of perfluoropolyether-silane at room temperature for I minute under ambient atmosphere. The mold is then kept under the conditions of 95% humidity at 65° C. for 1 hour after which it is rinsed for 10 minutes or more to remove the excess perfluoropolyether-silane from the mold surface and then dried. A disadvantage of this process is that it requires a relatively large quantity of fluorocarbon solvent to rinse the mold in order to achieve the desired imprint patterns.

Bailey et al., J Vac. Sci. Technol., B 18(6), 3572-3577 (2000) describe the use of quartz as the mold material. However, the total contact surface area between the quartz and the mold material is much greater than that between the molding material and the underlying substrate. The greater surface energy between the mold surface and molding material causes the molding material to simply peel off the substrate and stick to the mold. To lower the surface energy to facilitate release of the mold, the surface of the mold must treated with tridecafluoro-1,1,2,2, tetrahydrooctyl trichlorosilane (CF₃—(CF₂)₅—CH₂—CH₂—SiCl₃) at 90° C. for 1 hour. This surface modifying agent uses chlorine groups to couple the hydroxy groups (—OH) at the quartz surface. A significant disadvantage of this surface treating process is that the silane used as the surface modifying agent is moisture-sensitive, and thus must be treated in a dry and inert gas atmosphere. The release of hydrochloric acid (HCl) during the surface treatment process also gives rise to environmental and health concerns and requires a gas exhaust for the treatment system.

Chou et al., Appl. Phys. Lett., 67(21), 3114-3116, (1995) and J. Vac. Sci. Technol., B 14(6), 4129-4133 (1996) describe using silicon dioxide and silicon as the mold materials. The mold is fabricated using e-beam lithography and reactive ion etching and is then used without any further mold surface coating or treatment. However, mold-release agents are added to the molding material (polymethyl methacrylate, also known as PMMA) to reduce the adhesion of PMMA to the mold. The addition of mold-release agents may alter the original properties of the materials and adversely affect subsequent processing. The mold-release agents may also deteriorate the adhesion of the molding materials on the substrate surface. Another drawback with this method is that different molding materials may need different mold-release agents to achieve material compatibility.

### SUMMARY OF THE INVENTION

The present invention is broadly concerned with novel nonstick molds and methods of using these molds as negatives in the microelectronic fabrication process.

In more detail, the nonstick molds or negatives are patterned on at least one surface thereof with structures (topography, lines, features, etc.) which is designed to transfer the desired pattern to a microelectronic substrate. Advantageously and unlike prior art molds, the entire mold of this invention is formed of a nonstick material, thus eliminating the problems associated with prior art molds.

Nonstick materials suitable for use in the invention include those materials recognized in the art as having nonstick properties. Preferably, the surface energy of the material (as determined by contact angle measurements) is less than about 30 dyn/cm, more preferably less than about 18 dyn/cm, and even more preferably less than about 10 dyn/cm. Examples of suitable such materials include those selected from the group consisting of fluoropolymers, fluorinated siloxane polymers, silicones, and mixtures thereof, with fluorinated ethylene propylene copolymers, polytetrafluoroethylene, perfluoroalkoxy polymers, and ethylene-tetrafluoroethylene polymers being particularly preferred.

The inventive nonstick molds are formed by pressing a piece of nonstick material as described above against a master mold. This nonstick material can be provided in film form or as pellets, both of which are available commercially, although this material should be thoroughly cleaned as is conventional and necessary with equipment and materials utilized in this art.

The master mold is designed according to known processes and is selected to have microelectronic topography corresponding to that desired on the final microelectronic substrate (e.g., silicon wafers, compound semiconductor wafers, glass substrates, quartz substrates, polymers, dielectric substrates, metals, alloys, silicon carbide, silicon nitride, sapphire, and ceramics). The pressing of the nonstick mold against the master mold can be accomplished by any pressing means so long as the necessary uniform pressure can be applied.

Preferably, the pressure applied during the pressing step is from about 5-200 psi, and more preferably from about 10-100 psi. As far as temperatures are concerned, it is preferable that the nonstick material be heated to a temperature of from about the T_{g} of the nonstick material to about 20° C. above the melting point of the nonstick material during and/or prior to the pressing step. Even more preferably, the temperature will be from about the melting point of the nonstick material to about 10° C. above its melting point. Thus, although those skilled in the art will understand that this temperature will vary depending upon the nonstick material being utilized, and that the temperature utilized is also related to and dependent upon the pressure to be applied, typical temperatures will be from about 100-400° C., and more preferably from about 150-300° C. during and/or prior to the pressing step. The pressing step should be carried out for sufficient time to transfer the image from the master mold to the nonstick material. Although this is dependent upon the pressing temperatures and pressures, this time period will typically be from about 0.5-10 minutes, and more preferably from about 2-5 minutes. Finally, this press process can be carried out under an ambient pressure or under a vacuum atmosphere.

The nonstick mold should then be allowed to cool to about room temperature and then separated from the master mold to yield the inventive nonstick mold or negative. The nonstick mold can be used alone as a free-standing body, or it can be attached to a support for stamping or rolling (e.g., to the outer surface of a cylinder). As an alternative to this process, the nonstick molds can be formed from known injection molding processes.

Advantageously, the inventive nonstick mold or negative can then be used as an imprint lithography tool to imprint images onto a substrate. In this process, a flowable composition is applied (such as by spin-coating) to the surface of a substrate so as to form a layer or film of the composition on the substrate. This layer will typically be from about 0.1-500 μm thick, depending upon the final desired topography, with the thickness of the nonstick mold preferably being chosen to be greater than that of the flowable composition layer. The flowable composition can be photo-curable (e.g., epoxies, acrylates, organosilicon with a photo-initiator added), thermally curable, or any other type of composition conventionally used in the art.

The nonstick mold is then pressed against the flowable composition layer for sufficient time and at sufficient temperatures and pressures to transfer the negative image of the nonstick mold to the layer of flowable composition. It may be necessary to heat the composition to its flow temperature prior to and/or during this step. The pressing step will generally comprise applying pressures of from about 5-200 psi, and more preferably from about 10-70 psi, and will be carried out at temperatures of from about 18-250° C., and more preferably from about 18-135° C., This process is preferably carried out in a chamber evacuated to less than about 20 Torr, and more preferably from about 0-1 Torr, although ambient conditions are suitable as well. It will be understood that an optical flat or some equivalent means can be used to apply this pressure, and that the chosen pressure-applying means must be selected to adapt to the particular process (e.g., a UV-transparent optical flat is necessary if a UV-curing process is to be utilized).

While the mold and substrate are maintained in contact, the flowable composition is hardened or cured by conventional means. For example, if the composition is photo-curable, then it is subjected to UV light (at a wavelength appropriate for the particular composition) so as to cure the layer. Likewise, if the composition is thermally curable, it can be cured by application of heat (e.g., via a hotplate, via an oven, via IR warming, etc.) followed by cooling to less than its T_{g}, and preferably less than about 50° C. Regardless of the hardening or curing means, the mold is ultimately separated from the substrate, yielding a substrate patterned as needed for further processing.

It will be appreciated that the inventive processes possess significant advantages in that a wide range of dimensions can be achieved by these processes. For example, the inventive processes can be used to form substrates having topography and feature sizes of less than about 5 μm, less than about 1 μm, and even submicron (e.g., less than about 0.5 μm). At the same time, in applications where larger topography and feature sizes are desirable (e.g., such as in MEMS and packaging applications), topography and feature sizes of greater than about 100 μm, and even as large as up to about 50,000 μm can be obtained. As used herein, “topography” refers to the height or depth of a structure while “feature size” refers to the width and length of a structure. If the width and length are different, then it is conventional to reference the smaller number as the feature size.

### BRIEF DESCRIPTION OF THE DRAWINGS

FIG. 1 schematically depicts the steps for forming a nonstick mold according to the invention; and

FIG. 2 schematically depicts the use of a nonstick mold according to the invention to transfer the negative pattern from the nonstick mold to an impressible substrate.

### DETAILED DESCRIPTION OF THE PREFERRED EMBODIMENTS

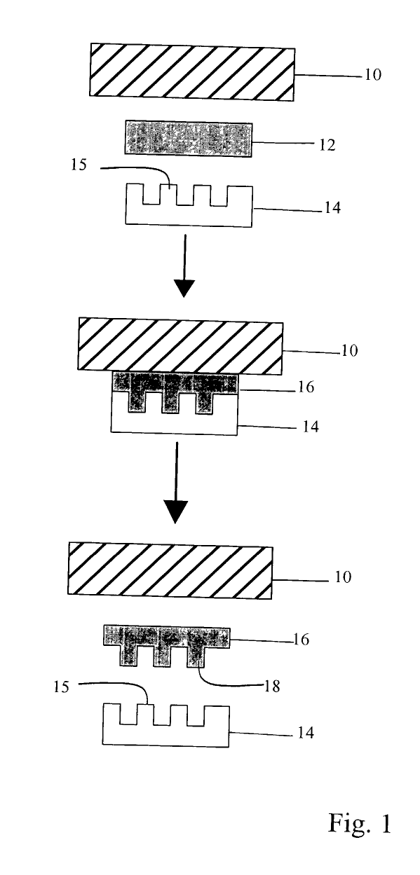

Referring to FIG. 1, an optical flat 10, a disk 12, and a master mold 14 are provided. Disk 12 is formed of a nonstick material such as one of those described above (e.g., FEP polymer). Furthermore, disk 12 is preferably ultrasmooth and ultra clean as is commonly known in the art.

Master mold 14 can be formed of any conventional material and by known fabrication methods (e.g., photolithography, e-beam lithography, etc.). Master mold 14 has a surface 15 that is patterned with structure and topography as needed for the particular intended purpose. During fabrication, the disk 12 is placed between the optical flat 10 and the master mold 14 as shown in FIG. 1, with each of the optical flat 10 and the master mold 14 preferably being in contact with respective hotplates. Furthermore, the surface 15 of the master mold 14 is positioned adjacent (i.e., facing) the disk 12.

The disk 12 is then pressed against the optical flat as illustrated for sufficient time, pressure, and temperature (depending upon the properties of the material of which disk 12 is formed) to cause disk 12 to be imprinted by surface 15, with the surface 15 and optical flat 10 being maintained substantially parallel to one another during the course of the entire press process. After pressing, the combination is preferably allowed to cool, and the optical flat 10 and master mold 14 are separated in order to remove the resulting nonstick mold 16. As shown, nonstick mold 16 now has a negative pattern 18 of the master mold surface 15.

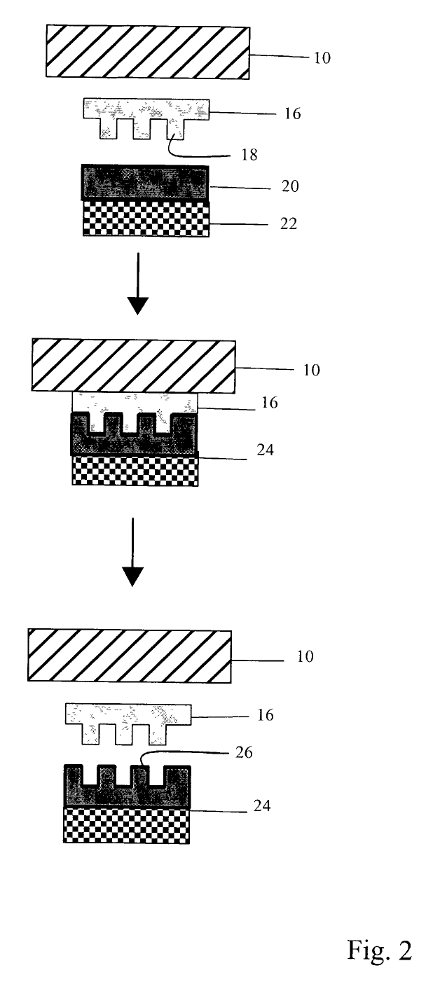

Referring to FIG. 2, the nonstick mold 16 can now be used to form patterns on imprintable or impressible surfaces. Thus, in addition to the optical flat 10, a moldable or imprintable material 20 and a substrate 22 are provided, with the material 20 being in contact with the substrate 22. Material 20 is preferably a flowable composition that can be photocured or thermocured, or that is thermoplastic. The material 20 can be applied to the substrate 22 by any known methods (e.g., spin-coating). The material 20 should be applied to the substrate 22 at a thickness that is preferably greater than the topography of the negative pattern 18.

The optical flat 10 and the substrate 22 are spaced apart with the nonstick mold 16 positioned therebetween. It is important that the negative pattern 18 of nonstick mold 16 be faced towards the impressible material 20. The pattern 18 and substrate 22 are preferably maintained substantially parallel to one another. Optical flat 10 and substrate 22 are then pressed together (again, for time, temperature and pressure suitable for the properties of the particular impressible material 20 being utilized) so as to cause the negative pattern 18 to be transferred to the impressible material 20, thus resulting in a precursor circuit structure 24 having the desired pattern 26.

### EXAMPLES

The following examples set forth preferred methods in accordance with the invention. It is to be understood, however, that these examples are provided by way of illustration and nothing therein should be taken as a limitation upon the overall scope of the invention.

### Example 1

### Fabrication of 1-μm Topography FEP Patterned Film and Pattern Transferring Using A Photo-Curable Material

An FEP Teflon® film (obtained from Du Pont) was trimmed to an appropriate size. This FEP film was then thoroughly cleaned to remove organic residue and particles at its surface. The FEP film was placed onto a pre-cleaned object surface with 1-μm topography line structures. The line width was from 12.5-μm to 237.5-μm. This patterned object surface was used as the master mold. Another object with an ultra-smooth surface was placed on top of the FEP film with the smooth surface facing the FEP film. The master mold/FEP film/smooth surface object stack was heated to 280° C. A total pressure of 64 psi was applied from the top and bottom sides of the stack. This pressure was applied for 5 minutes. The press process was carried out under ambient atmospheric conditions, although it could also be carried out in a vacuum and under other conditions. This pressure was applied for 5 minutes. The pressure was then released, and the stack was cooled to room temperature and disassembled. The negative pattern of the master mold was transferred to the FEP film surface. The resulting patterned FEP film was greater than 6 inches in diameter and could be used as a mold to transfer patterns to other substrate surfaces as described below.

A photo-curable epoxy composition was formed by mixing a novolac epoxy (50 wt %, Dow Chemical DEN431) with propylene glycol methyl ether acetate (50 wt %). Next, 1-3 wt % of triarylsulphonium hexafluorophosphate (a photo-acid generator) was added to this mixture, with the percentage by weight of triarylsulphonium hexafluorophosphate being based upon the weight of the novolac epoxy that was utilized.

A 1.5-μm thick film of the photo-curable epoxy composition was coated onto a 6-inch silicon wafer surface. The wafer was placed onto a wafer stage in a press chamber with the epoxy-coated surface facing a UV-transparent, optical flat object. The patterned FEP film was placed between the wafer and the optical flat object, with the patterned surface facing the epoxy-coated wafer. The press chamber was sealed and evacuated to less than 20 Torr, and the wafer stage was raised to press the wafer against the patterned FEP film which, in turn, pressed against the optical flat surface with a pressure of 64 psi for 1 minute. While the FEP film was in contact with the optical flat surface, UV light was illuminated through the optical flat to cure the epoxy. Once the epoxy was cured, the press pressure was released. The wafer stage was lowered, and the chamber was vented. The patterned FEP film was separated from the wafer surface. The pattern of the master mold with 1-μm topography was transferred to the 6-inch epoxy-coated wafer surface.

### Example 2

### Pattern Transferring Using a Radiant Thermal Process With a 1-μm Topography FEP Patterned Film

A 15-μm pre-polymer (dry etch benzocyclobutene, hereinafter referred to as “dry etch BCB,” available from Dow Chemicals, CYCLOTENE 3000 series) was coated onto a 6-inch silicon wafer surface. This wafer was baked at 135° C. for 7 minutes. The wafer was then transferred to the preheat wafer stage, which was set at a temperature of 150° C., in a press chamber with the polymer-coated surface facing an optical flat object. The patterned FEP film used in Example 1 was placed between the wafer and the optical object, with the patterned surface facing the polymer-coated wafer surface. The press chamber was sealed and evacuated to less than 20 Torr, and the wafer stage was raised to press the wafer against the patterned FEP film which, in turn, pressed against the optical flat surface with a press pressure of 64 psi for 1 minute. The wafer stage was then cooled to less than 50° C., with the press pressure being maintained during cooling. The wafer stage was lowered, and the chamber was vented. The patterned FEP film was then separated from the wafer surface. The pattern of the master mold with 1-μm topography had been successfully transferred to the polymer-coated wafer surface.

### Example 3

### Pattern Transferring Using an Infrared (IR) Thermal Process With a 1-μm Topography FEP Patterned Film

A 15-μm thick film of dry etch BCB was coated onto a 6-inch silicon wafer surface. This wafer was baked at 135° C. for 7 minutes. The wafer was then transferred to the wafer stage in a press chamber with the polymer-coated surface facing an IR-transparent optical flat object. The patterned FEP film used in Example 1 was placed between the wafer and the optical object, with the patterned surface facing the polymer-coated wafer surface. The press chamber was sealed and evacuated to less than 20 Torr. IR light was illuminated through the optical object and FEP film to heat the polymer until it reached its flow temperature. The wafer stage was then raised to press the wafer against the patterned FEP film which, in turn, pressed against the optical flat surface with a pressure of 64 psi for 1 minute as the IR heating was continued to maintain the flow temperature. The IR heating was stopped, and the wafer was then cooled for 30 seconds. The press pressure was released. The wafer stage was lowered, and the chamber was vented. The patterned FEP film was separated from the wafer surface. The pattern of the master mold with 1-μm topography had been transferred to the polymer-coated wafer surface.

### Example 4

### Fabrication of a 0.5-μm Topography FEP Patterned Film and Pattern Transferring Using a Photo-Curable Material

An FEP Teflon® film was trimmed to the desired size. This FEP film was then thoroughly cleaned to remove organic residue and particles from its surface. The film was placed onto a pre-cleaned object surface having 0.5-μm topography with feature sizes ranging from 3-μm to 500-μm structures. This patterned object surface was used as the master mold. Another object with an ultra-smooth surface was placed on top of the FEP film with the smooth surface facing the FEP film. The master mold/FEP film/smooth object stack was heated to 280° C. A total pressure of 64 psi was applied from the top and bottom sides of the stack for 5 minutes. The press process was carried out under an ambient atmosphere. After the pressure was released, the stack was cooled to room temperature. The stack was then disassembled. The negative pattern of the master mold was transferred to the FEP film surface. This patterned surface on the FEP film was greater than 6 inches in diameter and was then used as a mold to transfer patterns to other substrate surfaces as described below.

A 1.5-μm thick layer photo-curable epoxy was coated onto a 6-inch silicon wafer surface. This wafer was placed onto a wafer stage in a press chamber with the epoxy-coated surface facing a UV-transparent optical flat object. The patterned FEP film was placed between the wafer and optical flat object, with the patterned surface facing the epoxy-coated wafer. The press chamber was sealed and evacuated to less than 20 Torr. The wafer stage was raised to press the wafer against the patterned FEP film which pressed against the optical flat surface with a pressure of 64 psi for 1 minute. While still in contact with the optical flat surface, UV light was illuminated through the optical flat surface to cure the epoxy. Once the epoxy had cured, the press pressure was released, the wafer stage was lowered, and the chamber was vented. The patterned FEP film was separated from the wafer surface, and the pattern of the master mold with 0.5-μm topography had been transferred to the 6-inch epoxy-coated wafer surface.

### Example 5

### Pattern Transferring Using a Radiant Thermal Process With a 0.5-μm Topography FEP Patterned Film

A 15-μm thick layer of dry etch BCB was coated onto a 6-inch silicon wafer surface. This wafer was baked at 135° C. for 7 minutes. The wafer was then transferred to the wafer stage, which had been preheated to a temperature of 150° C., in a press chamber with the polymer-coated surface facing an optical flat object. The patterned FEP film used in Example 4 was placed between the wafer and optical object. The press chamber was sealed and evacuated to less than 20 Torr, and the wafer stage was raised to press the wafer against the patterned FEP film which then pressed against the optical flat surface with a pressure of 64 psi for 1 minute. The wafer stage was then cooled to less than 50° C., while the press pressure was maintained. After the wafer stage had cooled, it was lowered, and the chamber was vented. The patterned FEP film was then separated from the wafer surface. The pattern of the master mold with 0.5-μm topography was successfully transferred to the polymer-coated wafer surface.

### Example 6

### Pattern Transferring Using an Infrared (IR) Thermal Process With a 0.5 μm Topography FEP Patterned Film

A 15-μm thick layer of dry etch BCB was coated onto a 6-inch silicon wafer. This wafer was baked at 135° C.. for 7 minutes. The wafer was then transferred to the wafer stage in a press chamber with the polymer-coated surface facing an IR-transparent optical flat object. The patterned FEP film used in Example 4 was placed between the wafer and the optical object. The press chamber was sealed and evacuated to less than 20 Torr. IR light was illuminated through the optical object to heat the polymer to its flow temperature. The wafer stage was then raised to press the wafer against the patterned FEP film which then pressed against the optical flat surface with a pressure of 64 psi for 1 minute. IR heating was continued to maintain the flow temperature during the press process. IR heating was then stopped, the wafer was cooled for 30 seconds, and the press pressure was released. The wafer stage was lowered, and the chamber was vented. The patterned FEP film was then separated from the wafer surface. The pattern of the master mold with 0.5-μm topography had been transferred to the polymer-coated wafer surface.

### Example 7

### Fabrication of 5-μm Topography FEP Patterned Film and Pattern Transferring Using a Thermo-Curable Material

An FEP Teflon® film was trimmed to an appropriate size. This FEP film was thoroughly cleaned to remove organic residue and particles at its surface. This FEP film was placed onto a pre-cleaned object surface with 5-μm topography with feature sizes in the range of 50-μm to over 5000-μm structures. This patterned object surface was used as the master mold. Another object with an ultra-smooth surface was placed on top of the FEP film with the smooth surface facing the FEP film. The master mold/FEP film/smooth object surface stack was heated to 280° C. A total pressure of 35 psi was applied from the top and bottom sides of the stack. The pressure was applied for 4 minutes. The press process for this sample was carried out under ambient atmospheric conditions. The pressure was released, and the stack was cooled to room temperature. The stack was then disassembled, and the pattern of the master mold was transferred to the FEP film surface. The result was a patterned FEP film greater than 6 inches in diameter that was used as a mold to transfer patterns to other substrate surfaces.

A >5-μm thick film of dry etch BCB was coated onto a 6-inch silicon wafer surface. This wafer was baked at 150° C. for 1 minute. The wafer was then transferred to the preheat wafer stage (temperature of 175° C.) in a press chamber with the polymer-coated surface facing an optical flat object. The patterned FEP film, with 5-μm topography, was placed between the wafer and the optical flat object. The wafer stage was raised to press the wafer against the patterned FEP film which, in turn, pressed against the optical flat surface with a press pressure of 21 psi for 5 minutes. The entire pressed object was then cooled to <75° C., with the press pressure being maintained at 21 psi. The press pressure was then released, and the wafer stage was lowered. The stack was removed from the press tool and allowed to cool to room temperature. The stack was disassembled, and the patterned FEP film was subsequently separated from the wafer surface. The pattern of the master mold with 5-μm topography was transferred to the polymer-coated wafer surface.

### Example 8

### Fabrication of 1-μm Topography FEP Patterned Film with 0.25-μm Structures and Pattern Transferring Using A Photo-Curable Material

An FEP Teflon® film was trimmed to an appropriate size. This FEP film was thoroughly cleaned to remove organic residue and particles at its surface. The FEP film was then placed onto a pre-cleaned object surface with 1-μm topography with feature sizes of from 0.25-μm to 50-μm structures. This patterned object surface was used as the master mold. Another object with an ultra-smooth surface was placed on top of the FEP film with the smooth surface facing the FEP film. The master mold/FEP film/smooth surface object stack was heated to 280° C. A total pressure of 64 psi was applied from the top and bottom sides of the stack. This pressure was applied for 5 minutes. The press process was carried out under ambient atmospheric conditions. The pressure was then released, and the stack was cooled to room temperature and then disassembled. The negative pattern of the master mold had been transferred to the FEP film surface. The result was a patterned FEP film (with a diameter of greater than 6 inches) which was used as a mold to transfer patterns to other substrate surfaces.

A 1.5-μm thick photo-curable epoxy was coated onto a 6-inch silicon wafer surface. This wafer was placed onto a wafer stage in a press chamber with the epoxy-coated surface facing a UV-transparent optical flat object. The patterned FEP film was placed between the wafer and the optical flat object, with the patterned surface facing the epoxy-coated wafer. The press chamber was sealed and evacuated to less than 20 Torr, and the wafer stage was raised to press the wafer against the patterned FEP film which, in turn, pressed against the optical flat surface with a pressure of 64 psi for 1 minute. While the FEP film was in contact with the optical flat surface, UV light was illuminated through the optical flat surface to cure the epoxy. After the epoxy was cured, the press pressure was released. The wafer stage was lowered, the chamber was vented, and the patterned FEP film was separated from the wafer surface. The pattern of the master mold of 1-μm topography with 0.25-μm structures was transferred to the 6-inch, epoxy-coated wafer surface.

### Example 9

### Pattern Transferring at Elevated Temperature Using a Photo-Curable Material

A layer approximately 13-μm thick of a UV curable material (photosensitive benzocyclobutene, sold by Dow Chemicals under the name CYCLOTENE 4000 series) was coated onto a 6-inch silicon wafer. The wafer was then transferred onto a wafer stage (preheated to 135° C.) in a press chamber with the polymer-coated surface facing a UV transparent optical flat object. The patterned FEP film used in Example 4 was placed between the wafer and optical object, with the patterned surface facing the wafer. This wafer was baked on the wafer stage for 1 minute. The press chamber was sealed and evacuated to less than 20 Torr. While at 135° C., the wafer stage was raised to press the wafer against the patterned FEP film which pressed against the optical flat surface with a press pressure of 64 psi for 1 minute. While still in contact with the optical flat surface, UV light was illuminated through the optical flat to cure the coated material. Once the material was cured, the press pressure was released, the wafer stage was lowered, and the chamber was vented. The patterned FEP film was separated from the wafer surface. The pattern of the master mold with 0.5-μm topography was transferred to the 6-inch wafer surface.

### Example 10

### Fabrication of 1-μm Topography FEP Patterned Film from FEP Pellets and Pattern Transferring Using a Photo-Curable Material

A pre-cleaned object surface with 1-μm topography line structures was placed onto a substrate stage. The line structures on the object surface were 12.5 μm to 237.5 μm wide. This patterned object surface was used as the master mold. The patterned object surface was covered with an FEP resin that was in the form of about 2-3 mm pellets. Another object with an ultra-smooth surface was place on top of the FEP pellets with the smooth surface facing the FEP material. This master mold/FEP pellets/optical flat object stack was heated to 280° C. A total pressure of 64 psi was applied from the top and bottom sides of the stack for 5 minutes. The press process was carried out under ambient atmospheric conditions. The pressure was then released, and the stack was cooled to room temperature and disassembled. An FEP film with a negative pattern of the master mold was fabricated from the FEP pellets. This patterned FEP film (which was greater than 6 inches in diameter) was then used as a mold to transfer patterns to other substrate surfaces.

A 1.5-μm thick film of photo-curable epoxy was coated onto a 6-inch silicon wafer surface. The wafer was placed onto a wafer stage in a press chamber with the epoxy-coated surface facing a UV-transparent optical flat object. The patterned FEP film was placed between the wafer and the optical flat object, with the patterned surface facing the epoxy-coated wafer. The press chamber was sealed and evacuated to less than 20 Torr, and the wafer stage was raised to press the wafer against the patterned FEP film which pressed against the optical flat surface with a pressure of 64 psi for 30 seconds. While the FEP film was in contact with the optical flat surface, UV light was illuminated through the optical flat to cure the epoxy. Once the epoxy was cured, the pressure was released, the wafer stage was lowered, and the chamber was vented. The patterned FEP film was separated from the wafer surface. The pattern of the master mold with 1-μm topography was transferred to the 6-inch epoxy-coated wafer surface.

### Example 11

### Pattern Transferring Using a Thermal Process with Infrared (IR) Wafer Backside Heating

A 15-μm thick film of dry etch BCB was coated onto a 6-inch silicon wafer. This wafer was baked at 135° C. for 7 minutes. A patterned FEP film with a 0.5-μm topography pattern was placed onto the wafer stage in the press chamber, with the patterned surface of the film facing away from the stage surface. The polymer-coated wafer was transferred into the press chamber. The wafer was placed between the FEP film and an optical flat object with the polymer-coated surface facing the patterned FEP film surface. The backside of the wafer was facing the optical flat object. The press chamber was sealed and evacuated to less than 20 Torr. An infrared (IR) light was illuminated through the optical object to heat up the backside of the wafer to reach the polymer flow temperature. The wafer stage was then raised with a press pressure of 64 psi for 2 minutes in order to cause the FEP film to press against the polymer-coated wafer which pressed against the optical flat object surface. During the press process, the press temperature was maintained by IR illumination through the optical flat object. The wafer was then cooled for 1 minute, without IR heating, to below the flow temperature of the coated polymer. The press pressure was released, and the wafer stage was lowered. The press chamber was vented, and the patterned FEP film was separated from the wafer surface. The pattern of the master mold with 0.5-μm topography was transferred to the polymer-coated wafer surface.

### Example 12

### Pattern Transferring Using a Thermoplastic Material

A 2.7-μm thermoplastic material, polymethyl methacrylate (PMMA), was coated onto a 6-inch silicon wafer surface. This wafer was baked in the press chamber at 120° C. for 30 seconds on the preheat wafer stage, with the polymer-coated surface of the wafer facing an optical flat object. The patterned FEP film with 1-μm topography was placed between the wafer and the optical flat object. The wafer stage was raised to press the wafer against the patterned FEP film which, in turn, pressed against the optical flat surface with a press pressure of 34 psi for 5 minutes. The press pressure was released, and the wafer stage was lowered. The wafer/FEP film/optical flat object stack was removed from the press tool and allowed to cool to room temperature, and the stack was disassembled. Subsequently, the patterned FEP film was separated from the wafer surface. The pattern of the master mold with 1.0-μm topography was transferred to the PMMA-coated wafer surface.

### Example 13

### Rolling Pattern Transferring

A patterned FEP film was attached onto a 4.5-inch diameter cylinder with the patterned surface facing outward. A 15-μm thick pre-polymer dry etch BCB was coated onto a 6-inch silicon wafer surface. This wafer was baked at 150° C. for 1 minute. The FEP film-attached cylindrical object was rolled evenly across the wafer surface at 150° C. in about 3 seconds. The heat source was removed from the wafer and allowed to cool to room temperature. The pattern of the master mold with 1-μm topography was transferred to the polymer-coated wafer surface. This example was successfully repeated with a baking temperature of 100° C. for 1 minute and a rolling temperature of 100° C. for 5 seconds.

We claim:

1. A negative used in the fabrication of microelectronic devices which comprise a substrate and an impressible layer on the substrate, said negative having a pattern including a plurality of topography features, said negative comprising a unitary body formed of a nonstick material and including an impression surface, said body having sufficient rigidity to impress said pattern into the surface of said layer during said fabrication.

2. The negative of claim 1, said material having a surface energy of less than about 30 dyn/cm.

3. The negative of claim 1, further including a support secured to said body along a surface remote from said impression surface.

4. The negative of claim 3, wherein said support is a cylinder having an outer surface, and said body is secured to said outer surface.

5. The negative of claim 1, wherein said material is selected from the group consisting of fluoropolymers, fluorinated siloxane polymers, silicones, and mixtures thereof.

6. The negative of claim 5, wherein said material is selected from the group consisting of fluorinated ethylene propylene copolymers, polytetrafluoroethylene, perfluoroalkoxy polymers, and ethylene-tetrafluoroethylene polymers.

7. The combination of:
a microelectronic substrate having an impressible surface; and
a negative having an impression surface which comprises a pattern including a plurality of topography features, said negative comprising a unitary body formed of a nonstick material, said body having sufficient rigidity to impress said pattern into the surface of said substrate.

8. The combination of claim 7, said material having a surface energy of less than about 30 dyn/cm.

9. The combination of claim 7, wherein said material is selected from the group consisting of fluoropolymers, fluorinated siloxane polymers, silicones, and mixtures thereof.

10. The combination of claim 9, wherein said material is selected from the group consisting of fluorinated ethylene propylene copolymers, polytetrafluoroethylene, perfluoroalkoxy polymers, and ethylene-tetrafluoroethylene polymers.

11. The combination of claim 7, wherein said substrate is selected from the group consisting of silicon wafers, compound semiconductor wafers, glass substrates, quartz substrates, organic polymers, dielectric substrates, metals, alloys, silicon carbide, silicon nitride, sapphire, and ceramics.

12. A method of transferring a pattern, said method comprising the steps of:
providing a negative having an impression surface which comprises a pattern including a plurality of topography features, said negative comprising a unitary body formed of a nonstick material; and
contacting said negative with a microelectronic substrate having an impressible surface under conditions to impress said pattern into the surface of said impressible surface.

13. The method of claim 12, wherein said contacting step comprises pressing said negative against said substrate with a pressure of from about 5-200 psi.

14. The method of claim 12, wherein said contacting step is carried out at a temperature of from about 18-250° C.

15. The method of claim 12, wherein said pattern impressed into said impressible surface comprises topography of less than about 5 μm.

16. The method of claim 12, wherein said pattern impressed into said impressible surface comprises feature sizes of less than about 5 μm.

17. The method of claim 12, wherein said pattern impressed into said impressible surface comprises topography of from about 100-50,000 μm.

18. The method of claim 12, wherein said pattern impressed into said impressible surface comprises feature sizes of from about 100-50,000 μm.

19. The method of claim 12, wherein said impressible surface comprises a photo-curable composition, and further including the step of, after or during said contacting step, subjecting said composition to UV light for sufficient time to substantially cure said composition.

20. The method of claim 12, wherein said impressible surface comprises a thermally curable composition, and further including the step of, prior to or during said contacting step, heating said composition to its flow temperature.

21. The method of claim 20, wherein said contacting step comprises pressing said negative against said impressible surface and maintaining said negative against said impressible surface until said composition is cooled to a temperature of less than about the T_{g} of the composition.

22. The method of claim 20, wherein said heating step comprises subjecting said composition to IR light.

23. The method of claim 22, wherein said heating step comprises subjecting said composition to IR light by applying IR light to a surface of said substrate opposite from said impressible surface.

24. The method of claim 12, said material having a surface energy of less than about 30 dyn/cm.

25. The method of claim 12, further including a support secured to said body along a surface remote from said impression surface.

26. The method of claim 25, wherein said support is a cylinder having an outer surface, and said body is secured to said outer surface.

27. The method of claim 26, wherein said contacting step comprises rolling said cylinder with sufficient pressure against said impressible surface so as to impress said pattern into said impressible surface.

28. The method of claim 12, wherein said material is selected from the group consisting of fluoropolymers, fluorinated siloxane polymers, silicones, and mixtures thereof.

29. The method of claim 28, wherein said material is selected from the group consisting of fluorinated ethylene propylene copolymers, polytetrafluoroethylene, perfluoroalkoxy polymers, and ethylene-tetrafluoroethylene polymers.

30. The method of claim 12, wherein said substrate is selected from the group consisting of silicon wafers, compound semiconductor wafers, glass substrates, quartz substrates, organic polymers, dielectric substrates, metals, alloys, silicon carbide, silicon nitride, saphire, and ceramics.

31. A method of forming a nonstick mold for use in the fabrication of microelectronic devices, said method comprising the steps of:
providing a master mold having a patterned surface including a plurality of topography features;
pressing a nonstick material against said patterned surface under conditions for forming a negative of said patterned surface in said material; and
separating said nonstick material from said surface to yield the nonstick mold.

32. The method of claim 31, further including the step of applying said nonstick mold to an outer surface of a support after said separating step.

33. The method of claim 31, wherein said pressing step comprises applying a pressure of from about 5-200 psi to said nonstick material.

34. The method of claim 31, wherein said nonstick material is heated to a temperature of from about 100-400° C. prior to or during said pressing step.

35. The method of claim 31, wherein said pressing step is carried out for a time period of from about 0.5-10 minutes.

36. The method of claim 34, wherein said nonstick material is cooled to room temperature prior to said separating step.

37. The method of claim 31, said nonstick material having a surface energy of less than about 30 dyn/cm.

38. The method of claim 31, wherein said nonstick material is selected from the group consisting of fluoropolymers, fluorinated siloxane polymers, silicones, and mixtures thereof.

39. The method of claim 38, wherein said nonstick material is selected from the group consisting of fluorinated ethylene propylene copolymers, polytetrafluoroethylene, perfluoroalkoxy polymers, and ethylene-tetrafluoroethylene polymers.

40. The method of claim 31, wherein said pressing step is carried out under ambient pressure.

41. The method of claim 31, wherein said pressing step is carried out under a vacuum atmosphere.
